(19) United States
(12) Patent Application Publication
(10) Pub. No.: US 2026/0107087 A1
(43) Pub. Date: Apr. 16, 2026

(54) ACOUSTICALLY TRANSPARENT DISPLAY WITH ANGLED ACOUSTIC WAVEGUIDES

(71) Applicant: CHRISTIE DIGITAL SYSTEMS USA, INC., Cypress, CA (US)

(72) Inventor: Brian CLAYPOOL, Seal Beach, CA (US)

(21) Appl. No.: 18/912,809

(22) Filed: Oct. 11, 2024

(51) Int. Cl. H04R 1/34; H04R 1/02

(52) U.S. Cl. CPC H04R 1/345; H04R 1/028; H04R 2499/15

(57) ABSTRACT

An acoustically transparent display device is provided in the form of a device comprising: a display panel; light sources arranged on a front surface of the display panel; and apertures through the display panel, the apertures disposed between the light sources. To better aim sound from a speaker towards an audience, the device is further provided with acoustic waveguides arranged on a rear surface the display panel, the acoustic waveguides arranged at a portion of the apertures, the acoustic waveguides being angularly offset from a normal to the rear surface of the display panel, to guide sound, received at the rear surface, through the portion of the apertures at a non-zero angle to a respective normal of the front surface of the display panel.

### BACKGROUND

Emissive display technologies, such as light emitting diode displays, are increasingly being used in theaters and other types of environments. However, one of the challenges with emissive display technologies is their usage may prohibit speakers from being placed behind the displays, because a substrate and/or display panel, on which light sources are arranged, blocks sound from speakers behind the displays.

### BRIEF DESCRIPTIONS OF THE DRAWINGS

For a better understanding of the various examples described herein and to show more clearly how they may be carried into effect, reference will now be made, by way of example only, to the accompanying drawings in which:

FIG. 1 depicts a front side of an acoustically transparent display with angled acoustic waveguides, according to non-limiting examples.

FIG. 2 depicts a partial cross-section through a line A-A of the acoustically transparent display of FIG. 1, and walls of the angled acoustic waveguides are further depicted in perspective, according to non-limiting examples.

FIG. 3 depicts a top view of an acoustically transparent display with angled acoustic waveguides that directs sound rightward and outward, according to non-limiting examples.

FIG. 4 depicts a top view of an acoustically transparent display with angled acoustic waveguides that directs sound leftward and outward, according to non-limiting examples.

FIG. 5 depicts an acoustically transparent display mounted in a theater, with angled acoustic waveguides that direct sound out downward, leftward and rightward, as well as outward, according to non-limiting examples.

### DETAILED DESCRIPTION

Emissive display technologies, such as light emitting diode (LED) displays, are increasingly being used in theaters and other types of environments. However, in many instances, in such theaters, speakers may be difficult to mount on walls and/or around the theaters, and a general preference by theater owners and content creators may be that speakers be mounted behind emissive displays as that is where significant portions of the sound is meant to come from (voices of the actors on screen for example). To accommodate speakers behind the emissive displays, the emissive displays may be provided with apertures, through which sound from speakers mounted behind the emissive displays may travel to reach an audience. However, even such a configuration fails to take into account that the emissive displays, and the speakers may be mounted generally above an audience, and as such, the sound from the speakers may be directed over the heads of the audience or be perceived that the actors speaking are speaking from above the audience’s heads. As such, provided herein is an acoustically transparent display with angled acoustic waveguides. Such an acoustically transparent display with angled acoustic waveguides may more closely match the performance and directionality of traditional theater sound systems.

An aspect of the present specification provides a device comprising: a display panel; light sources arranged on a front surface of the display panel; apertures through the display panel, the apertures disposed between the light sources; and acoustic waveguides arranged on a rear surface the display panel, the acoustic waveguides arranged at a portion of the apertures, the acoustic waveguides being angularly offset from a normal to the rear surface of the display panel, to guide sound, received at the rear surface, through the portion of the apertures at a non-zero angle to a respective normal of the front surface of the display panel.

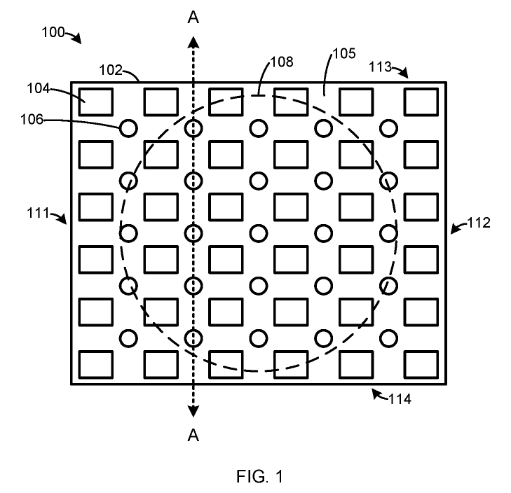

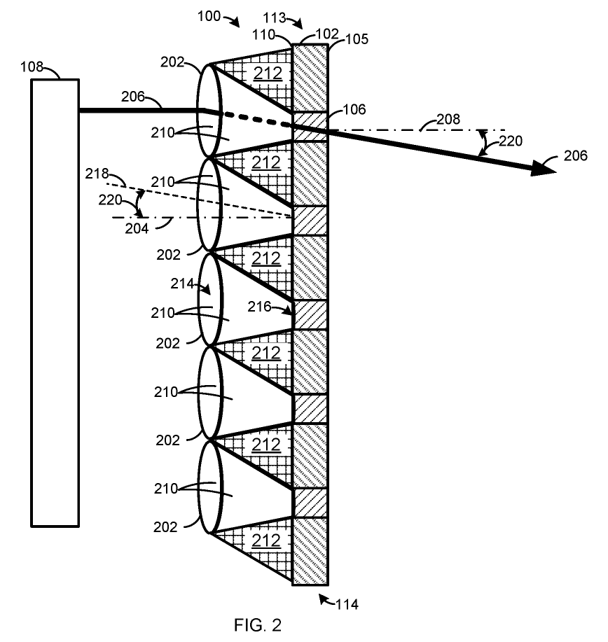

Attention is next directed to FIG. 1 and FIG. 2 which respectively depict a front view of a device 100, and a partial cross-section view of the device 100 through a line A-A of FIG. 1.

In particular, the device 100 comprises an acoustically transparent emissive display and/or a modular panel for such an acoustically transparent emissive display (e.g., when a plurality of the devices 100 are tiled together).

The device 100 comprises: a display panel 102, light sources 104 arranged on a front surface 105 of the display panel 102, and apertures 106 through the display panel 102, the apertures 106 disposed between the light sources 104. While only one light source 104 and one aperture 106 are indicated, it is understood that the device 100 comprises a plurality of light sources 104 arranged, for example, in an array, and/or in any other suitable configuration, with a plurality of apertures 106 arranged in an array that is offset relative to the array of light sources 104. While the aperture 106 are generally depicted as being located about a same distance from corners of four adjacent light sources 104, the apertures 106 may be in any suitable location between the light sources 104 and may or may not be arranged in an array.

The display panel 102 may comprise a printed circuit board (PCB), however the display panel 102 may comprise any suitable material and/or substrate that supports components of the device 100.

The light sources 104 may comprise light emitting diodes (LEDs), and/or any other suitable emissive light sources, including, but not limited to, organic light emitting diodes (OLEDs), and the like. Hence, the display panel 102 and the light sources 104 may form one or more of an LED panel and an LED display.

The light sources 104 may be controlled by an image generator (not depicted) to form images and/or video at the device 100. Hence, while not depicted, the device 100 is further understood to include electrical connections to the light sources 104, and a connector to an image generator, and/or any suitable connector(s) for tiling and/or electrically connecting the device 100 to other devices 100 to form a larger display. For example, such electrical connections may be integrated with the display panel. Such images and/or video may further be provided with sound, and hence, as depicted, a speaker 108 (and/or speakers) may be mounted behind the device 100 to provide such sound, which may pass through the apertures 106.

Indeed, the apertures 106 are generally are through the display panel 102 (e.g., from the front surface 105 to a rear surface 110 opposite front surface 105, the rear surface 110 best seen in FIG. 2) such that sound from the speaker 108 mounted behind the device 100 (e.g., adjacent a rear surface 110) may pass therethrough, for example to reach an audience viewing images and/or video presented at the device 100. In FIG. 1, the speaker 108 is depicted in outline indicating that the speaker 108 is located behind the device 100).

It is further understood that the speaker 108 may be arranged relative to edges of the device 100. In particular, it is understood that, when the device 100 is mounted in a theater (or other suitable environment) the device 100 has directionality, and hence is understood to include a left edge 111, a right edge 112, a top edge 113 and a bottom edge 114.

It is understood, however, that the speaker 108 is not necessarily a component of the device 100, but is depicted in FIG. 1 and FIG. 2 to indicate a portion of the device 100, where sound may be received from the speaker 108 and pass through the apertures 106. Such a region is referred to hereafter as the speaker region and/or a speaker region of the display panel 102. Indeed, in some examples, the apertures 106 may be located only in the speaker region (and/or may be located in the speaker region, though apertures 106 overlapping the speaker region may be included at the device 100) though, for ease of manufacture, the apertures 106 may be located across the display panel 102 including inside the speaker region and outside the speaker region.

However, as the sound may pass through the apertures 106 somewhat perpendicularly to the display panel 102, the sound may pass over an audience viewing the device 100. Indeed, in theaters, it is understood that speakers mounted behind displays (e.g., or screens), are generally mounted about two-thirds display and/or screen height from the floor, which tends to represent both a natural area in a picture where sound generally emanates (e.g., mouths of actors on-screen, that emit sound, tend to be about two-thirds display and/or screen height from a bottom of a display and/or screen and/or floor ) as well as for a more uniform dispersion of sound in the auditorium.

Hence, as best seen in FIG. 2, the device 100 further comprises acoustic waveguides 202 arranged on the rear surface 110 the display panel 102, the acoustic waveguides 202 arranged at least at a portion of the apertures 106 (e.g., in the speaker region), the acoustic waveguides 202 being angularly offset from a normal 204 to the rear surface 110 of the display panel 102, to guide sound 206, received at the rear surface 110, through the portion of the apertures 106 at a non-zero angle to a respective normal 208 of the front surface 105 of the display panel 102.

Furthermore, to illustrate certain geometry of the acoustic waveguides 202, the acoustic waveguides 202 are drawn in a perspective view in FIG. 2, though it is understood that such a perspective view is a distortion relative to the otherwise cross-sectional view of the other components of the device 100 depicted in FIG. 2.

While for simplicity the sound 206 is depicted as entering only one acoustic waveguide 202 adjacent the top edge 113, it is understood that the sound 206 may be emitted across a surface of the speaker 108 and may enter all the acoustic waveguides 202.

Furthermore, in FIG. 2, walls 210 of the acoustic waveguides 202 are depicted (e.g., not in cross-section) to illustrate that the acoustic waveguides 202 may be generally conic and may comprise oblique frustums, as described in more detail below.

It is further understood that the acoustic waveguides 202 and/or the walls 210 are rigid and hence the walls 210 are supported by rigid material 212 between the walls 210 (and/or at the walls 210, for example at any of the edges 111, 112, 113, 114). Indeed, openings in the rigid material 212 may define the walls 210.

Furthermore, to assist with the acoustic waveguides 202 being non-resonant to a given set of frequencies, the acoustic waveguides 202 may comprise a rigid and/or dense material, such as one or more of metal (e.g., aluminum), a rigid plastic (e.g., polycarbonate), and the like.

For example, for frequencies in a range of about 20 Hz to about 20 kHz, which is an average range of frequencies of sound of many videos or movies, a circular aperture 106 may be at least 1.7 mm in diameter (e.g., for sound of 20 kHz to pass therethrough), though preferably a circular aperture 106 may be at about 34 mm in diameter and/or between about 1.7 mm and about 34 mm, with a diameter of the sound-emitting opening 216 being of about a same size as a diameter of a respective aperture 106.

Hence, a diameter of the apertures 106 may be selected based on a given wavelength or a given frequency of the sound 206.

However, in some examples, the speaker 108 may comprise a two-way speaker, a three-way speaker or a four-way speaker, with different frequency ranges being emitted in different regions of the speaker 108. In such examples, a diameter of the apertures 106 may vary depending on frequencies emitted by the speaker 108 in the different regions of the speaker 108 to which the apertures 106 are adjacent. For example, the speaker region of the display panel 102 may be divided into two more speaker sub-regions associated with different frequency ranges and respective diameters of apertures 106 in the different sub-regions may be different with respective diameters of apertures 106 in lower-frequency speaker sub-regions being larger than respective diameters of apertures 106 in higher-frequency speaker sub-regions.

Similarly, one or more of a shape and size of the acoustic waveguides 202 is selected to be non-resonant to a given set of frequencies, such as frequencies in a range of about 20 Hz to about 20 kHz. For example, for sound of 20 kHz, a length of the acoustic waveguides 202 (e.g., along the normal 204 from the rear surface 110, and/or along an axis 218 (described in more detail below), for example to a maximum distance from the rear surface 110) may be in a range of about 7 mm to 10 mm, and preferably, for 20 kHz, about 8.6 mm. For example, such a length may be defined as a distance of a peak of a cross-section of the rigid material 212 from the rear surface 110, and/or a perpendicular distance between the openings 214, 216.

More particularly, as will be described herein, the acoustic waveguides 202 may comprise one or more of portions of cones and oblique frustums extending from the rear surface 110 the display panel 102, and a length of the cones and/or the oblique frustums may be selected based on a given wavelength or a given frequency of the sound 206, and with a size of the aperture 202 similarly adapted.

In yet further examples, a color of the acoustic waveguides 202 may be selected that is generally non-reflective to light, such that light from the light sources 104, that may scatter into the apertures 106, is not reflected by the acoustic waveguides 202. For example, the acoustic waveguides 202 may be black, dark grey, dark brown, and/or any other suitable color.

A shape of the acoustic waveguides 202 is next discussed, however the acoustic waveguides 202 may comprise one or more of portions of cones and oblique frustums, extending from the rear surface 110 the display panel 102.

As illustrated at one acoustic waveguide 202 in FIG. 2 (e.g., for simplicity), each acoustic waveguide 202 generally includes a larger sound-accepting opening 214 that, when the device 100 is mounted adjacent the speaker 108, channels sound 206 to a smaller sound-emitting opening 216. A size and shape of the sound-emitting openings 216 may be defined by respective apertures 106, and/or are generally aligned with, and/or a same diameter and/or same size and/or same shape of respective apertures 106.

For example, an acoustic waveguide 202 is understood to comprise a speaker-facing side at which the sound-accepting opening 214 is provided, and an acoustic waveguide 202 is further understood to comprise an aperture-facing side at which the sound-emitting opening 216 is provided. Furthermore, the walls 210 extend between the sound-accepting opening 214 and the sound-emitting opening 216, and furthermore the walls 210 narrow from the sound-accepting opening 214 to the sound-emitting opening 216.

Put another way, the acoustic waveguides 202 are further understood to be hollow between the sound-accepting opening 214 and the sound-emitting opening 216, and furthermore may generally narrow from the sound-accepting opening 214 to the sound-emitting opening 216. However, an acoustic waveguide 202 may have any suitable shape which channels sound received at a speaker-facing side through a respective aperture 106.

Similarly, while as depicted, the apertures 106 are circular, and hence the conic shape of the acoustic waveguides 202, the sound-accepting opening 214 and the sound-emitting opening 216 are also generally circular, the apertures 106 and the acoustic waveguides 202 may have any suitable shape that narrows from a speaker-facing side of the acoustic waveguides 202. For example the apertures 106, the conic shape of the acoustic waveguides 202, the sound-accepting opening 214 and the sound-emitting opening 216 may be elliptical, or square or rectangular (e.g., such that the shape of the acoustic waveguides 202 is pyramidal), or any other suitable shape.

In particular, however, the acoustic waveguides 202 are depicted as oblique frustums. For example, an oblique frustum is a type of frustum where the walls of a truncated cone (e.g., or pyramid) are not perpendicular to the base. In other words, an axis of the cone or pyramid from which the frustum is derived is slanted or tilted, for example relative to the base, making the shape "oblique”.

In particular, it is understood that a frustum may be formed by slicing a top off a cone or pyramid with a plane parallel to the base, creating two parallel faces (the top and the bottom). When the axis of the cone is perpendicular to the base, the frustum is called a right frustum. However, when the axis is tilted or non-perpendicular, it becomes an oblique frustum.

Hence, as depicted, it is understood that an acoustic waveguide 202 may comprise an oblique frustum (e.g., formed and/or defined by the walls 210) with a “base” of the cone comprising a respective sound-accepting opening 214 and a “top” of a cone comprising a respective sound-emitting opening 216. As depicted the openings 214, 216 are parallel to each other, and perpendicular to the normal 204 of the rear surface 110, however an axis 218 of an acoustic waveguide 202 is non-perpendicular to the openings 214, 216. However, the openings 214, 216 need not be parallel with each other; for example, a respective sound-emitting opening 216 may form a traditional “top” of an oblique frustrum defined by the walls 210, but a corresponding sound-accepting opening 214 may be at any suitable angle to the speaker 108 and may, or may not be, parallel with the respective sound-emitting opening 216.

To illustrate the acoustic waveguides 202 being angularly offset from the normal 204 to the rear surface 110 of the display panel 102, attention is directed to the normal 204 of the rear surface 110 of the display panel 102, and the axis 218 that extends from the rear surface 110 of the display panel 102, about equidistant from the walls 210 of the acoustic waveguides 202. While only one axis 218 is depicted for simplicity, it is understood that each of the acoustic waveguides 202 comprises a respective axis 218. As depicted, the axis 218 forms a non-zero angle 220 with the normal 204. Furthermore, the axis 218 is understood to extend in a downward direction from the rear surface 110 to the front surface 105. As such, the sound 206 entering an acoustic waveguide 202 is directed, downwards, at the same angle 220 from the normal 208 to the front surface 105. As such, the sound 206 is directed downwards relative to the top edge 113 and/or the bottom edge 114.

Put another way, as depicted in FIG. 2, the acoustic waveguides 202 may be angularly offset from the normal 204 of the rear surface 110 of the display panel 102 at an angle 220 (e.g., the same angle 220 as the angular offset of the axis 218) toward the top edge 113, such that sound is directed downwards and outwards relative to the front surface 105.

However, the angular offset of the axis 218 may be in any suitable direction and may be selected to direct the sound 206 downwards, leftwards, rightwards, downwards and leftwards, or downwards and rightwards. In each instance the sound 206 is further understood to be directed outwards from the display panel 102, for example outwards from the front surface 105.

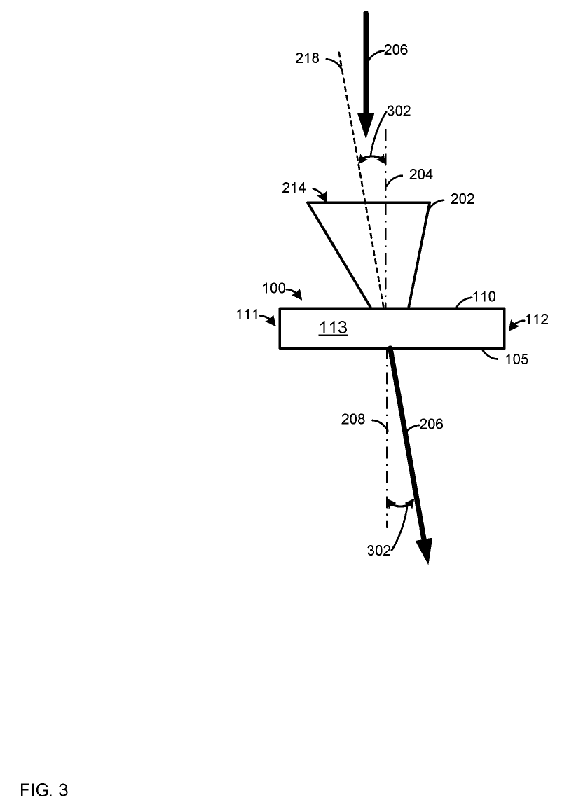

For example, attention is next directed to FIG. 3, which depicts a top view of another example of the device 100 and one acoustic waveguide 202 extending from the rear surface 110. While only one acoustic waveguide 202 is depicted for simplicity, the device 100 of FIG. 3 is understood to include a plurality of acoustic waveguides 202. Similarly, while not all components of the device 100 and the acoustic waveguide 202 are depicted in FIG. 3, they are nonetheless understood to be present, including, but not limited to, the light sources 104, the rigid material 212, etc.

However, in this example, the axis 218 of the acoustic waveguide 202 is angularly offset from the normal 204 of the rear surface 110 of the display panel 102 at an angle 302 toward the left edge 111, such that the sound 206, that is entering the acoustic waveguide 202 at the larger sound-accepting opening 214 is directed through a respective aperture 106 (not depicted, but nonetheless understood to be present) rightwards at the angle 302 with the normal 208 to the front surface 105, for example towards the right edge 112, and outwards relative to the front surface 105.

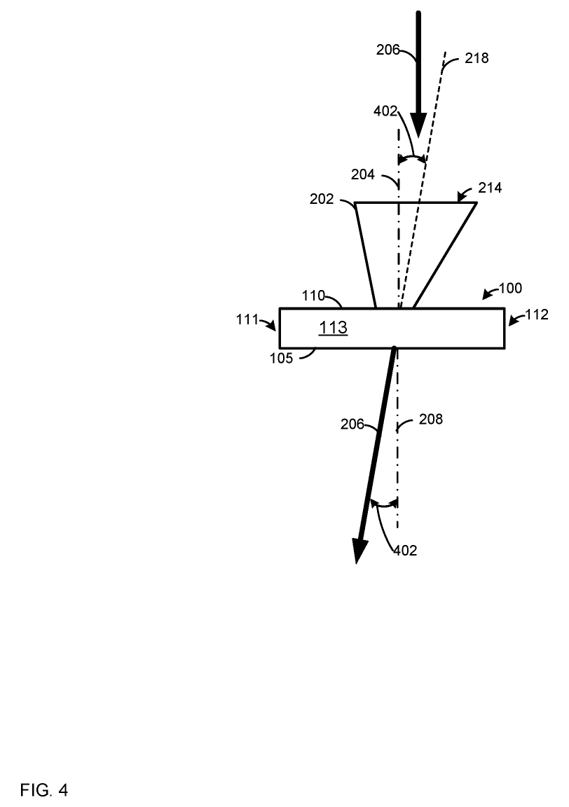

Attention is next directed to FIG. 4, which is substantially similar to FIG. 3, with like components having like numbers. However, in this example, the axis 218 of the acoustic waveguide 202 is angularly offset from the normal 204 of the rear surface 110 of the display panel 102 at an angle 402 toward the right edge 112, such that the sound 206, that is entering the acoustic waveguide 202 at the larger sound-accepting opening 214 is directed through a respective aperture 106 (not depicted, but nonetheless understood to be present) leftwards at the angle 402 with the normal 208 to the front surface 105, for example towards the left edge 111, and outwards relative to the front surface 105.

However, the axis 218 of an acoustic waveguide 202 may be in any suitable direction.

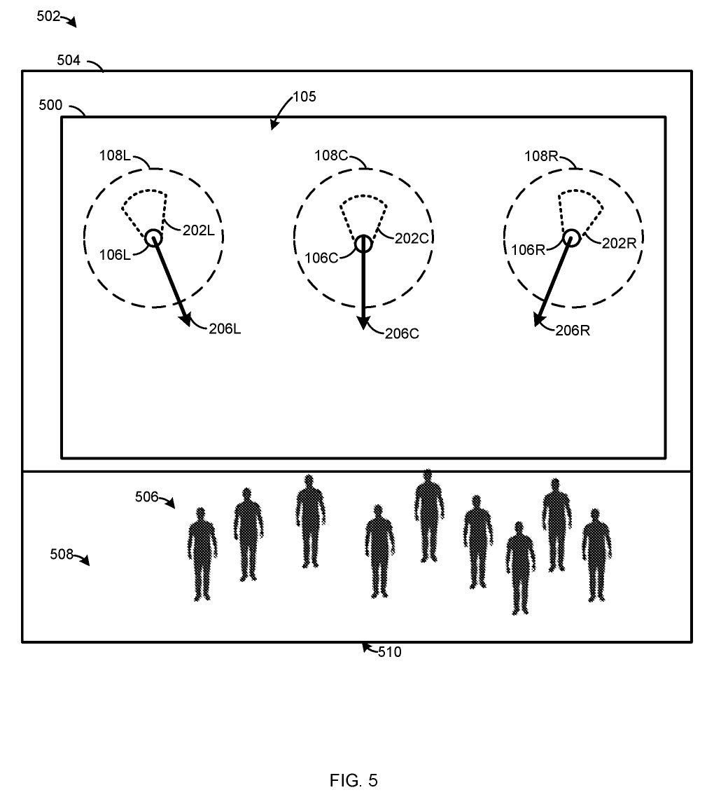

For example, attention is directed to FIG. 5, which depicts an example of a device 500, similar to the device 100, that has been mounted in a theater 502 and adapted for a size and shape suitable for mounting at a wall 504 of the theater 502, and with an audience 506 viewing the device 500, the audience 506 standing at a floor 508 of the theater 502 (though the audience 506 may be standing and/or sitting in seats). A location of a rear wall 510 of the theater 502 is also depicted. For simplicity, the device 500 is depicted without light sources 104, though light sources 104 are nonetheless understood to be present, such that images and/or video may be played at the device 500 with respective sound 206L, 206C, 206R (e.g., where “L”, “C”, and “R” respectively indicate left, center and right) from respective speakers 108L, 108C, 108R being directed through the device 500 towards the audience 506. Indeed, the sound 206L, 206C, 206R may respectively comprise left, center and right channels of sound of the images and/or video.

Furthermore, the device 500 is depicted with the left speaker 108L, the center speaker 108C and the right speaker 108R mounted behind the device 500 about two-thirds display height (e.g., e.g., the centers of the speakers 108L, 108C, 108R are about two-thirds display height from the floor 508 and/or about two-thirds a height of the device 500). The speakers 108L, 108C, 108R are depicted in outline to indicate their respective presence behind the device 500.

Furthermore, the device 500 is provided with different types of acoustic waveguides 202L, 202C, 202C at respective rear surfaces 110 respectively in respective regions of the left speaker 108L, the center speaker 108C and the right speaker 108R. The acoustic waveguides 202L, 202C, 202C are depicted in outline to indicate their respective presence at a rear surface of the device 500.

While the device 500 is depicted with only three apertures 106L, 106C, 106R, the device 500 is understood to include any suitable number of apertures 106.

Similarly, while only one each of the acoustic waveguides 202L, 202C, 202C are depicted, the device 500 is understood to include any suitable number of acoustic waveguides 202, and respective apertures 106, with, for example, a plurality of acoustic waveguides 202L and respective apertures 106L in a region of the left speaker 108L, a plurality of acoustic waveguides 202C and respective apertures 106C in a region of the center speaker 108C, and a plurality of acoustic waveguides 202R and respective apertures 106R in a region of the right speaker 108R.

With brief reference to FIG. 2 and FIG. 3, the left acoustic waveguide 202L is understood to have an axis 218 that is both at an angle 220 and at an angle 302 to a normal 204 to a rear surface of the device 500. As such sound 206L from the left speaker 108L is directed rightwards and downwards (e.g., and outwards towards the audience 506).

Similarly, and with brief reference to FIG. 2 and FIG. 4, the right acoustic waveguide 202R is understood to have an axis 218 that is both at an angle 220 and at an angle 402 to a normal 204 to a rear surface of the device 500. As such sound 206R from the right speaker 108R is directed leftwards and downwards (e.g., and outwards towards the audience 506).

With brief reference to FIG. 2, the center acoustic waveguide 202C is understood to have an axis 218 that is both at an angle 220 to a normal 204 to a rear surface of the device 500. As such sound 206C from the center speaker 108C is directed downwards (e.g., and outwards towards the audience 506).

Hence, by providing the device 500 with three types of acoustic waveguides 202L, 202C, 202R, for the three different positions of the speakers 108L, 108C, 108R, the respective sound 206L, 206C, 206R may be better directed towards the audience 506 and not, for example over their heads.

Further details of the device 100 and/or the device 500 are now described.

For example, with attention directed back to FIG. 2, an acoustic waveguide 202 may be provided at each aperture 106 through which the line A-A extends.

In some examples, the acoustic waveguides 202 are arranged at least at the portion of the apertures 106 located in a speaker region of the display panel 102. In some of these examples, an acoustic waveguide 202 is provided at each aperture 106 of the device 100, whereas in other examples, the acoustic waveguides 202 are arranged only at the portion of the apertures 106 located in the speaker region of the display panel 102 (and overlapping the speaker region).

As has been previously described, the display panel 102 has a left edge 111, a right edge 112, a top edge 113 and a bottom edge 114, and the acoustic waveguides 202, with reference to FIG. 2, may be angularly offset from the normal 204 to the rear surface 110 of the display panel 102 at one or more angles 220 toward the top edge 113, for example to direct the sound 206 downwards and outwards. Put another way, while the device 100 has been described with respect to one angle 220, different angles 220 may be used for different acoustic waveguides 202, such that acoustic waveguides 202 located closer to the top edge 113 are at larger angles 220 than acoustic waveguides 202 located closer to the bottom edge 114. For example, when such a configuration is adopted in the device 500 of FIG. 5, in the region of the center speaker 108C, such a configuration may better direct the sound 206C entering the acoustic waveguides 202C closer to the top edge 113 of the device 500 at a larger downward angle 220, towards the audience 506, than downward angles 220 of acoustic waveguides 202C closer to the bottom edge 114 of the device 500, which may be closer to the audience 506.

In some examples, the one or more angles 220 toward the top edge 113 may be between about 2° and about 12° from the normal 204 to the rear surface 110 the display panel 102. In these examples, the acoustic waveguides 202 may direct the sound 206 downwards (and outwards), as with the acoustic waveguide 202C. In certain examples, the one or more angles 220 may be at about 10°, which may be suitable for display sizes and speaker positions of theaters.

However, in other examples, with reference to FIG. 3, the acoustic waveguides 202 are angularly offset from the normal 204 to the rear surface 110 of the display panel 102 at one or more angles 302 toward the left edge 111 (and may, or may not, also be at an angle 220 towards the top edge 113), for example to direct the sound 206 rightwards and outwards. Put another way, while the device 100 has been described with respect to one angle 302, different angles 302 may be used for different acoustic waveguides 202, such that acoustic waveguides 202 located closer to the left edge 111 are at larger angles 302 than acoustic waveguides 202 located closer to the right edge 112. For example, when such a configuration is adopted in the device 500 of FIG. 5, in the region of the left speaker 108L, such a configuration may better direct the sound 206L entering the acoustic waveguides 202L closer to the left edge 113 of the device 500 at a larger rightward angle 302, towards the audience 506, than rightward angles 302 of acoustic waveguides 202L in the region of the left speaker 108L closer to the right edge 112 of the device 500, which may be closer to the audience 506.

In some examples, the one or more angles 302 toward the left edge 111 may be between about 5° and about 15° from the normal 204 to the rear surface 110 the display panel 102. In these examples, the acoustic waveguides 202 may direct the sound 206 rightwards (and outwards), as with the acoustic waveguide 202L. In certain examples, the one or more angles 220 may be at about 5°, which may be suitable for display sizes and speaker positions of theaters.

However, in other examples, with reference to FIG. 4, the acoustic waveguides 202 are angularly offset from the normal 204 to the rear surface 110 of the display panel 102 at one or more angles 402 toward the right edge 112 (and may, or may not, also be at an angle 220 towards the top edge 113), for example to direct the sound 206 leftwards and outwards. Put another way, while the device 100 has been described with respect to one angle 402, different angles 402 may be used for different acoustic waveguides 202, such that acoustic waveguides 202 located closer to the left edge 111 are at larger angles 402 than acoustic waveguides 202 located closer to the right edge 112. For example, when such a configuration is adopted in the device 500 of FIG. 5, in the region of the right speaker 108R, such a configuration may better direct the sound 206R entering the acoustic waveguides 202R closer to the right edge 112 of the device 500 at a larger rightward angle 302, towards the audience 506, than rightward angles 302 of acoustic waveguides 202R in the region of the right speaker 108R closer to the left edge 111 of the device 500, which may be closer to the audience 506.

In some examples, the one or more angles 402 toward the right edge 112 may be between about 5° and about 15° from the normal 204 to the rear surface 110 the display panel 102. In these examples, the acoustic waveguides 202 may direct the sound 206 leftwards (and outwards), as with the acoustic waveguide 202L. In certain examples, the one or more angles 220 may be at about 5°, which may be suitable for display sizes and speaker positions of theaters.

In yet further examples, the acoustic waveguides 202 are angularly offset from the normal 204 to the rear surface 110 of the display panel 102 at one or more first angles 220 toward the top edge 113 and one or more second angles 302, 402 toward the left edge 111 or the right edge 112. Put another way, the acoustic waveguides 202 may be angularly offset at two angles: at an angle 220 towards the top edge 113 and at an angle 302 towards the left edge 111, in the left acoustic waveguide 202L of FIG. 5; or at an angle 220 towards the top edge 113 and at an angle 402 towards the right edge 112, in the right acoustic waveguide 202R of FIG. 5.

In some examples, the one or more first angles 220 toward the top edge 113 may be between about 2° and about 12° from the normal 204 to the rear surface 110 of the display panel 102, and the one or more angles toward the left edge 111 or the right edge 112 may be between about 5° and about 15° from the normal 204 to the rear surface 110 of the display panel 102.

Furthermore the device 500 may comprise a plurality of different devices 100 tiled together, with different types of acoustic waveguides 202L, 202C, 202C at respective rear surfaces 110. Furthermore, devices 100 outside the speaker regions may or may not include apertures or acoustic waveguides. For example, as the speakers 108L, 108C, 108R may be

Indeed, the device 500 may be assembled from four types of devices 100: one or more devices 100 having the acoustic waveguides 202L that are mounted in the region of the speaker 108L and direct the sound 206L downwards, leftwards, and outwards toward the audience 506; one or more devices 100 having the acoustic waveguides 202C that are mounted in the region of the speaker 108C and direct the sound 206C downwards and outwards toward the audience 506; one or more devices 100 having the acoustic waveguides 202R that are mounted in the region of the speaker 108R and direct the sound 206R downwards, rightwards, and outwards toward the audience 506; and one or more devices 100 having no acoustic waveguides (but that may or may not include apertures 106). However the device 500 may be provided in any suitable manner.

It is further understood that the angles 220, 302, 402 may be selected based on a size of the theater 502 and in particular based on a distance from the speakers 108L, 108C, 108R (e.g., placed at two-thirds a height of the device 500) to the rear wall 510, which may be referred to hereafter as a length of the theater 502. In particular, the angles 220, 302, 402 may depend on the length of the theater 502, for example to aim the speakers 108L, 108C, 108R toward about a center of the theater 502, which will be further from the device 100, the longer the length of the theater 502. Put another way, as the length of the theater 502 increases, the angles 220, 302, 402 may decrease, and/or as the length of the theater 502 decreases, the angles 220, 302, 402 may increase.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one...” and “one or more...” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that there are yet more alternative examples and modifications possible, and that the above examples are only illustrations of one or more examples. The scope, therefore, is only to be limited by the claims appended hereto.

What is claimed is:

1. A device comprising:
a display panel;
light sources arranged on a front surface of the display panel;
apertures through the display panel, the apertures disposed between the light sources; and
acoustic waveguides arranged on a rear surface the display panel, the acoustic waveguides arranged at a portion of the apertures, the acoustic waveguides being angularly offset from a normal to the rear surface of the display panel, to guide sound, received at the rear surface, through the portion of the apertures at a non-zero angle to a respective normal of the front surface of the display panel.

2. The device of claim 1, wherein the acoustic waveguides are arranged at the portion of the apertures located in a speaker region of the display panel.

3. The device of claim 1, wherein the display panel has a left edge, a right edge, a top edge and a bottom edge, and
wherein the acoustic waveguides are angularly offset from the normal to the rear surface of the display panel at one or more angles toward the top edge.

4. The device of claim 3, wherein the one or more angles toward the top edge are between about 2° and about 12° from the normal to the rear surface the display panel.

5. The device of claim 1, wherein the display panel has a left edge, a right edge, a top edge and a bottom edge, and
wherein the acoustic waveguides are angularly offset from the normal to the rear surface of the display panel at one or more angles toward the left edge.

6. The device of claim 5, wherein the one or more angles toward the left edge are between about 5° and about 15° from the normal to the rear surface the display panel.

7. The device of claim 1, wherein the display panel has a left edge, a right edge, a top edge and a bottom edge, and
wherein the acoustic waveguides are angularly offset from the normal to the rear surface of the display panel at one or more angles toward the right edge.

8. The device of claim 7, wherein the one or more angles toward the right edge are between about 5° and about 15° from the normal to the rear surface the display panel.

9. The device of claim 1, wherein the display panel has a left edge, a right edge, a top edge and a bottom edge, and
wherein the acoustic waveguides are angularly offset from the normal to the rear surface of the display panel at one or more first angles toward the top edge and one or more second angles toward the left edge or the right edge.

10. The device of claim 9, wherein the one or more first angles toward the top edge are between about 2° and about 12° from the normal to the rear surface the display panel, and the one or more angles toward the left edge or the right edge are between about 5° and about 15° from the normal to the rear surface the display panel.

11. The device of claim 1, wherein the acoustic waveguides comprise cones extending from the rear surface the display panel between the apertures.

12. The device of claim 1, wherein the acoustic waveguides comprise one or more of portions of cones and oblique frustums extending from the rear surface the display panel between the apertures, and a length of one or more of the cones and the oblique frustums are selected based on a given wavelength or a given frequency of the sound.

13. The device of claim 1, wherein the display panel comprises a printed circuit board.

14. The device of claim 1, wherein the light sources comprise light emitting diodes.

15. The device of claim 1, the display panel and the light sources form one or more of a light emitting diode display (LED) panel and an LED display.

16. The device of claim 1, wherein a diameter of the apertures is selected based on a given wavelength or a given frequency of the sound.

17. The device of claim 1, wherein a color of the acoustic waveguides is non-reflective to light.

18. The device of claim 1, wherein the acoustic waveguides comprise a rigid material.

19. The device of claim 1, wherein one or more of a shape and size of the acoustic waveguides is non-resonant to a given set of frequencies.
